(19) United States
(12) Patent Application Publication
(10) Pub. No.: US 2010/0007643 A1
(43) Pub. Date: Jan. 14, 2010

(54) DRIVING CIRCUIT

(76) Inventors: Po-Chang Wu, Taichung County (TW); Wen-Chi Wu, Tao-Yuan City (TW); Chi-Mo Huang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 12/265,738

(22) Filed: Nov. 6, 2008

(30) Foreign Application Priority Data
Jul. 14, 2008 (TW) 097126628

(51) Int. Cl. G06F 3/038

(52) U.S. Cl. 345/211

(57) ABSTRACT

The present invention provides a driving circuit. The driving circuit includes: an amount Z of first level shifting units, an amount B of second level shifting units, a first matrix decoding unit, an amount C of third level shifting units, an amount D of fourth level shifting units, a second matrix decoding unit, and a third matrix decoding unit. The driving circuit can generate an amount (Z×B)×(C×D) of high voltage digital output signals. The driving circuit provided by the present invention can significantly decrease the required high voltage elements (i.e. the level shifting units), and thus the present invention can reduce area of the driving circuit efficiently.

### BACKGROUND OF THE INVENTION

1. Field of the Invention

The present invention relates to a driving circuit, and more particularly, to a gate driver applied to a LCD panel, and the gate driver provided by the present invention can significantly decrease the required high voltage elements (i.e. the level shifting units) so as to reduce area of the gate driver.

2. Description of the Prior Art

Please refer to FIG. 1. FIG. 1 shows a simplified block diagram of a gate driver 100 applied to a LCD panel in accordance with a prior art. As shown in FIG. 1, the gate driver 100 comprises: a decoder 101, a plurality of level shifters 102, and a plurality of output stages 103, wherein each gate line of a plurality of gate lines G1-Gm requires a corresponding level shifter 102. A plurality of elements implemented in the level shifter 102 are mostly high voltage elements, and thus the gate driver 100 of the prior art has a very large area in general, and it is very difficult to reduce the area of the gate driver 100.

Please refer to FIG. 2. FIG. 2 shows a simplified block diagram of a matrix decoder 200 in a gate driver applied to a LCD panel in accordance with U.S. Publication No. 20070103346. The theory of the matrix decoder 200 mainly utilizes a 2D matrix decoding scheme to decreases the required high voltage elements (i.e. the level shifting units). However, the size of the current LCD panel is becoming much bigger recently, and the amount of the gate lines also becomes much more accordingly, and thus the above prior art is no longer capable of satisfying the requirements of the current LCD industry.

### SUMMARY OF THE INVENTION

It is therefore one of the objectives of the present invention to provide a driving circuit which is capable of decreasing the required high voltage elements (i.e. the level shifting units) to reduce area of the driving circuit, so as to solve the above problem.

In accordance with an embodiment of the present invention, a driving circuit is disclosed. The driving circuit comprises: an amount Z of first level shifting units, an amount B of second level shifting units, a first matrix decoding unit, an amount C of third level shifting units, an amount D of fourth level shifting units, a second matrix decoding unit, and a third matrix decoding unit. The amount Z of first level shifting units are utilized for respectively receiving one of an amount Z of first low voltage digital input signals, and for generating an amount Z of first high voltage digital input signals in accordance with the amount Z of first low voltage digital input signals. The amount B of second level shifting units are utilized for respectively receiving one of an amount B of second low voltage digital input signals, and for generating an amount B of second high voltage digital input signals in accordance with the amount B of second low voltage digital input signals. The first matrix decoding unit is coupled to the amount Z of first level shifting units and the amount B of second level shifting units, and utilized for receiving the amount Z of first high voltage digital input signals and the amount B of second high voltage digital input signals, and for generating an amount (Z×B) of first high voltage digital output signals in accordance with the amount Z of first high voltage digital input signals and the amount B of second high voltage digital input signals. The amount C of third level shifting units are utilized for respectively receiving one of an amount C of third low voltage digital input signals, and for generating an amount C of third high voltage digital input signals in accordance with the amount C of third low voltage digital input signals. The amount D of fourth level shifting units are utilized for respectively receiving one of an amount D of fourth low voltage digital input signals, and for generating an amount D of fourth high voltage digital input signals in accordance with the amount D of fourth low voltage digital input signals. The second matrix decoding unit is coupled to the amount C of third level shifting units and the amount D of fourth level shifting units, and utilized for receiving the amount C of third high voltage digital input signals and the amount D of fourth high voltage digital input signals, and for generating an amount (C×D) of second high voltage digital output signals in accordance with the amount C of third high voltage digital input signals and the amount D of fourth high voltage digital input signals. The third matrix decoding unit is coupled to the first matrix decoding unit and the second matrix decoding unit, and utilized for receiving the amount (Z×B) of first high voltage digital output signals and the amount (C×D) of second high voltage digital output signals, and for generating an amount (Z×B)×(C×D) of third high voltage digital output signals in accordance with the amount (Z×B) of first high voltage digital output signals and the amount (C×D) of second high voltage digital output signals.

In accordance with an embodiment of the present invention, a driving circuit is further disclosed. The driving circuit comprises: an amount Z of first level shifting units, an amount B of second level shifting units, a first matrix decoding unit, a plurality groups of third level shifting units, a matrix decoding module, and a third matrix decoding unit. The amount Z of first level shifting units are utilized for respectively receiving one of an amount Z of first low voltage digital input signals, and for generating an amount Z of first high voltage digital input signals in accordance with the amount Z of first low voltage digital input signals. The amount B of second level shifting units are utilized for respectively receiving one of an amount B of second low voltage digital input signals, and for generating an amount B of second high voltage digital input signals in accordance with the amount B of second low voltage digital input signals. The first matrix decoding unit is coupled to the amount Z of first level shifting units and the amount B of second level shifting units, and utilized for receiving the amount Z of first high voltage digital input signals and the amount B of second high voltage digital input signals, and for generating an amount (Z×B) of first high voltage digital output signals in accordance with the amount Z of first high voltage digital input signals and the amount B of second high voltage digital input signals. Each group of third level shifting units are utilized for respectively receiving one of a plurality of third low voltage digital input signals, and for generating a plurality of third high voltage digital input signals in accordance with the plurality of third low voltage digital input signals. The matrix decoding module is utilized for generating an amount (C×D) of second high voltage digital output signals, and the matrix decoding module comprises a plurality of second matrix decoding units. Each of the plurality of second matrix decoding units are utilized for generating a plurality of output signals in accordance with a plurality of first input signals and a plurality of second input signals, wherein an amount of the plurality of output signals is equal to a product of an amount of the plurality of first input signals and an amount of the plurality of second input signals, and the plurality of first input signals are outputs of an adjacent second matrix decoding unit or outputs of one group of third level shifting units in the plurality groups of third level shifting units, and the plurality of second input signals are outputs of an adjacent second matrix decoding unit or outputs of one group of third level shifting units in the plurality groups of third level shifting units, and a product of amounts of each group of third level shifting units in the plurality groups of third level shifting units is equal to (C×D). The third matrix decoding unit is coupled to the first matrix decoding unit and the matrix decoding module, and utilized for receiving the amount (Z×B) of first high voltage digital output signals and the amount (C×D) of second high voltage digital output signals, and for generating an amount (Z×B)×(C×D) of third high voltage digital output signals in accordance with the amount (Z×B) of first high voltage digital output signals and the amount (C×D) of second high voltage digital output signals.

In accordance with an embodiment of the present invention, a driving circuit is yet further disclosed. The driving circuit comprises: a plurality groups of first level shifting units, a first matrix decoding module, a plurality groups of second level shifting units, a second matrix decoding module, and a third matrix decoding unit. Each group of first level shifting units are utilized for respectively receiving one of a plurality of first low voltage digital input signals, and for generating a plurality of first high voltage digital input signals in accordance with the plurality of first low voltage digital input signals. The first matrix decoding module is utilized for generating an amount (Z×B) of first high voltage digital output signals, and the matrix decoding module comprises a plurality of first matrix decoding units, each of the plurality of first matrix decoding units for generating a plurality of first output signals in accordance with a plurality of first input signals and a plurality of second input signals, wherein an amount of the plurality of first output signals is equal to a product of an amount of the plurality of first input signals and an amount of the plurality of second input signals, and the plurality of first input signals are outputs of an adjacent first matrix decoding unit or outputs of one group of first level shifting units in the plurality groups of first level shifting units, and the plurality of second input signals are outputs of an adjacent first matrix decoding unit or outputs of one group of first level shifting units in the plurality groups of first level shifting units, and a product of amounts of each group of first level shifting units in the plurality groups of first level shifting units is equal to (Z×B). Each group of second level shifting units are utilized for respectively receiving one of a plurality of second low voltage digital input signals, and for generating a plurality of second high voltage digital input signals in accordance with the plurality of second low voltage digital input signals. The second matrix decoding module is utilized for generating an amount (C×D) of second high voltage digital output signals, and the second matrix decoding module comprises a plurality of second matrix decoding units, each of the plurality of second matrix decoding units for generating a plurality of second output signals in accordance with a plurality of first input signals and a plurality of second input signals, wherein an amount of the plurality of second output signals is equal to a product of an amount of the plurality of first input signals and an amount of the plurality of second input signals, and the plurality of first input signals are outputs of an adjacent second matrix decoding unit or outputs of one group of second level shifting units in the plurality groups of second level shifting units, and the plurality of second input signals are outputs of an adjacent second matrix decoding unit or outputs of one group of second level shifting units in the plurality groups of second level shifting units, and a product of amounts of each group of second level shifting units in the plurality groups of second level shifting units is equal to (C×D). The third matrix decoding unit is coupled to the first matrix decoding module and the second matrix decoding module, and utilized for receiving the amount (Z×B) of first high voltage digital output signals and the amount (C×D) of second high voltage digital output signals, and for generating an amount (Z×B)×(C×D) of third high voltage digital output signals in accordance with the amount (Z×B) of first high voltage digital output signals and the amount (C×D) of second high voltage digital output signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a gate driver applied to a LCD panel in accordance with a prior art.

FIG. 2 shows a simplified block diagram of a matrix decoder in a gate driver applied to a LCD panel in accordance with U.S. Publication No. 20070103346.

FIG. 3 shows a simplified block diagram of a gate driver applied to a LCD panel in accordance with a first embodiment of the present invention.

FIG. 4A and FIG. 4B show a simplified block diagram of a gate driver applied to a LCD panel in accordance with a second embodiment of the present invention.

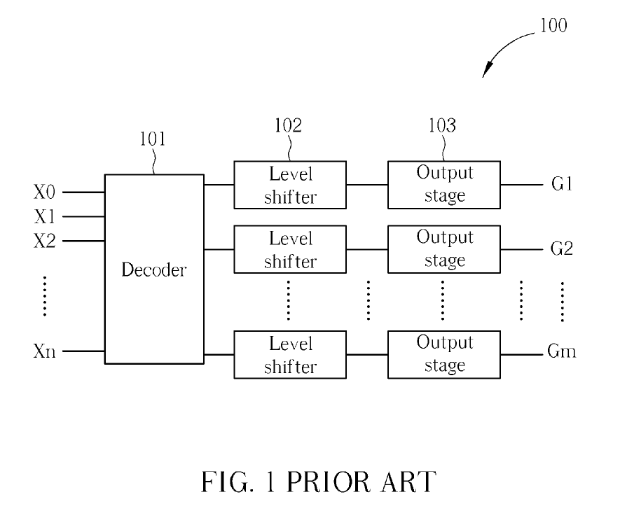

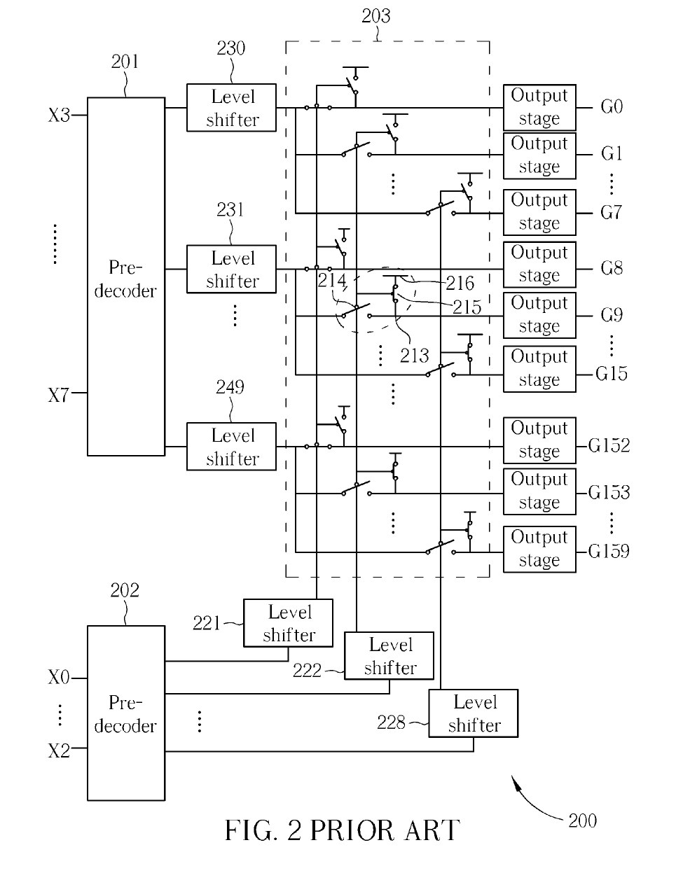

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

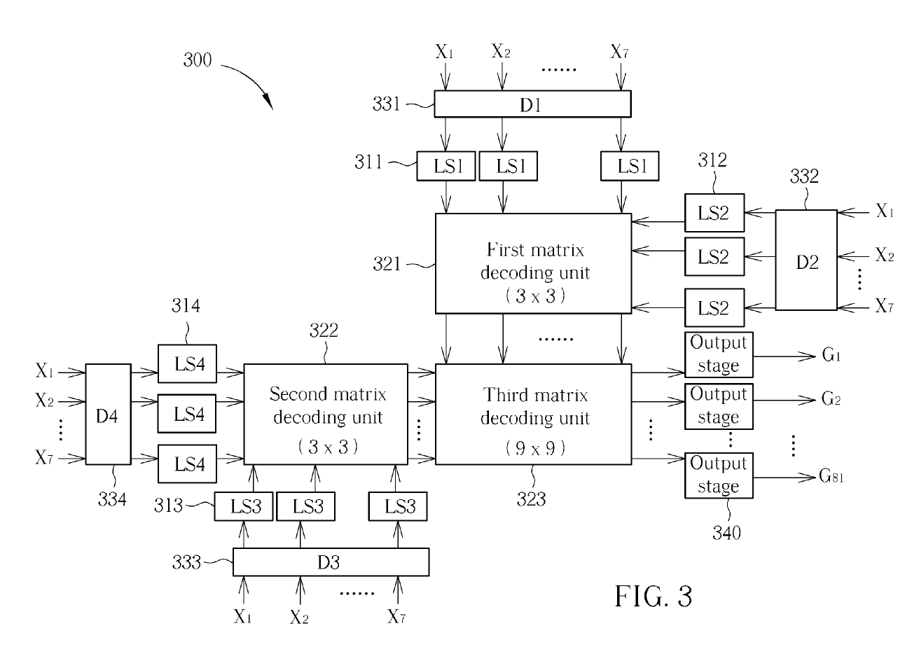

Please refer to FIG. 3. FIG. 3 shows a simplified block diagram of a gate driver 300 applied to a LCD panel in accordance with a first embodiment of the present invention. As shown in FIG. 3, the driving circuit 300 comprises: three first level shifting units (LS1) 311, three second level shifting units (LS2) 312, three third level shifting units (LS3) 313, three fourth level shifting units (LS4) 314, a first matrix decoding unit 321, a second matrix decoding unit 322, a third matrix decoding unit 323, a first decoding unit (D1) 331, a second decoding unit (D2) 332, a third decoding unit (D3) 333, a fourth decoding unit (D4) 334, and eighty-one output stages 340. The first decoding unit 331 is coupled to the three first level shifting units 311, and utilized for receiving a plurality of digital control signals X1-X7, and for generating three first low voltage digital input signals (not shown) in accordance with a portion of the plurality of digital control signals X1-X7. The second decoding unit 332 is coupled to the three second level shifting units 312, and utilized for receiving the plurality of digital control signals X1-X7, and for generating three second low voltage digital input signals (not shown) in accordance with at least a portion of the plurality of digital control signals X1-X7. The third decoding unit is 333 coupled to the three third level shifting units 313, and utilized for receiving the plurality of digital control signals X1-X7, and for generating three third low voltage digital input signals (not shown) in accordance with at least a portion of the plurality of digital control signals X1-X7. The fourth decoding unit 334 is coupled to the three fourth level shifting units 314, and utilized for receiving the plurality of digital control signals X1-X7, and for generating three fourth low voltage digital input signals (not shown) in accordance with at least a portion of the plurality of digital control signals X1-X7. Next, the three first level shifting units 311 are utilized for respectively receiving one of the three first low voltage digital input signals, and for generating three first high voltage digital input signals (not shown) in accordance with the three first low voltage digital input signals. The three second level shifting units 312 are utilized for respectively receiving one of the three second low voltage digital input signals, and for generating three second high voltage digital input signals (not shown) in accordance with the three second low voltage digital input signals. The first matrix decoding unit 321 is coupled to the three first level shifting units 311 and the three second level shifting units 312, and utilized for receiving the three first high voltage digital input signals and the three second high voltage digital input signals, and for generating an amount (3×3) of (i.e. nine) first high voltage digital output signals (not shown) in accordance with the three first high voltage digital input signals and the three second high voltage digital input signals. In other words, the first matrix decoding unit 321 is a (3×3) matrix decoding unit. The three third level shifting units 313 are utilized for respectively receiving one of the three third low voltage digital input signals, and for generating three third high voltage digital input signals (not shown) in accordance with the three third low voltage digital input signals. The three fourth level shifting units 314 are utilized for respectively receiving one of the three fourth low voltage digital input signals, and for generating three fourth high voltage digital input signals (not shown) in accordance with the three fourth low voltage digital input signals. The second matrix decoding unit 322 is coupled to the three third level shifting units 313 and the three fourth level shifting units 314, and utilized for receiving the three third high voltage digital input signals and the three fourth high voltage digital input signals, and for generating an amount (3×3) of (i.e. nine) second high voltage digital output signals (not shown) in accordance with the three third high voltage digital input signals and the three fourth high voltage digital input signals. In other words, the second matrix decoding unit 322 is a (3×3) matrix decoding unit. The third matrix decoding unit 323 is coupled to the first matrix decoding unit 321 and the second matrix decoding unit 322, and utilized for receiving the nine first high voltage digital output signals and the nine second high voltage digital output signals, and for generating an amount (9×9) of (i.e. eighty-one) third high voltage digital output signals (not shown) in accordance with the nine first high voltage digital output signals and the nine second high voltage digital output signals. In other words, the third matrix decoding unit 323 is a (9×9) matrix decoding unit. The eighty-one output stages 340 are coupled to the third matrix decoding unit 323, and utilized for receiving the eighty-one third high voltage digital output signals. In addition, each of the eighty-one output stages 340 is coupled to one of eighty-one gate lines G1-G81, respectively. In other words, the eighty-one output stages 340 and the eighty-one gate lines G1-G81 are corresponding to each other one by one. In addition, since the internal circuit structure and the operation scheme of the matrix decoding unit are well known to those of average skill in this art, and thus further explanation of the internal circuit structure and the operation scheme of the first matrix decoding unit 321, the second matrix decoding unit 322, and the third matrix decoding unit 323 are omitted herein for the sake of brevity.

Next, please note that the above embodiment is only for an illustrative purpose and is not meant to be a limitation of the present invention. The gate driver 300 of the present invention can be designed in accordance with different required output signal amounts. For example, when the required output signal amount is 160 (i.e. the same as the output signal amount of the gate driver in the U.S. Publication No. 20070103346 of the prior art), the gate driver 300 can comprises: four first level shifting units (LS1) 311, four second level shifting units (LS2) 312, a (4×4) first matrix decoding unit 321, five third level shifting units (LS3) 313, two fourth level shifting units (LS4) 314, a (5×2) second matrix decoding unit 322, a (16×10) third matrix decoding unit 323, a first decoding unit (D1) 331, a second decoding unit (D2) 332, a third decoding unit (D3) 333, a fourth decoding unit (D4) 334, and 160 output stages 340. It can be well understood from the content stated above that the gate driver of the present invention can significantly decrease the amount (from 28 to 15 for example, and the reduction range is 46.4%) of the required high voltage elements (i.e. the level shifting units) in comparison with the gate driver of the U.S. Publication No. 20070103346, and thus the present invention can reduce area of the driving circuit efficiently.

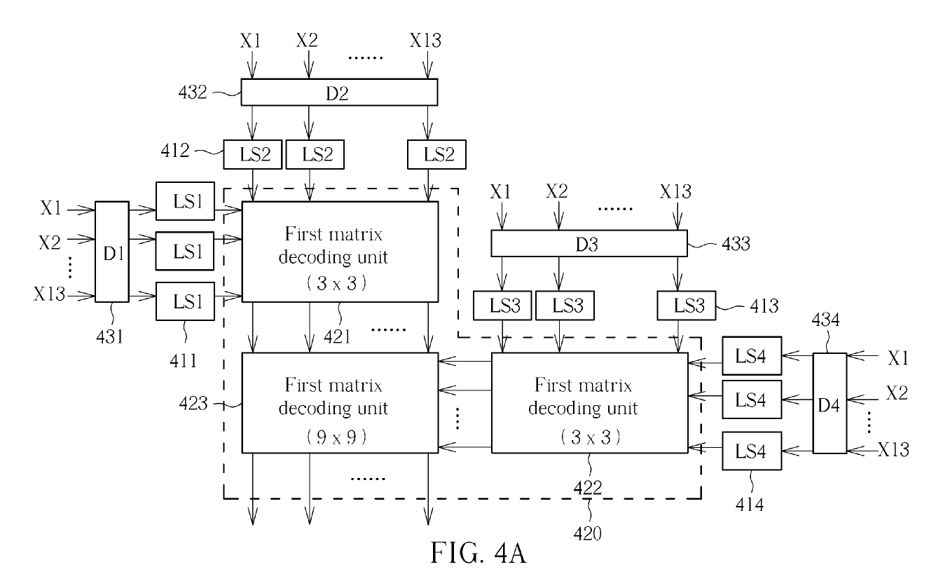

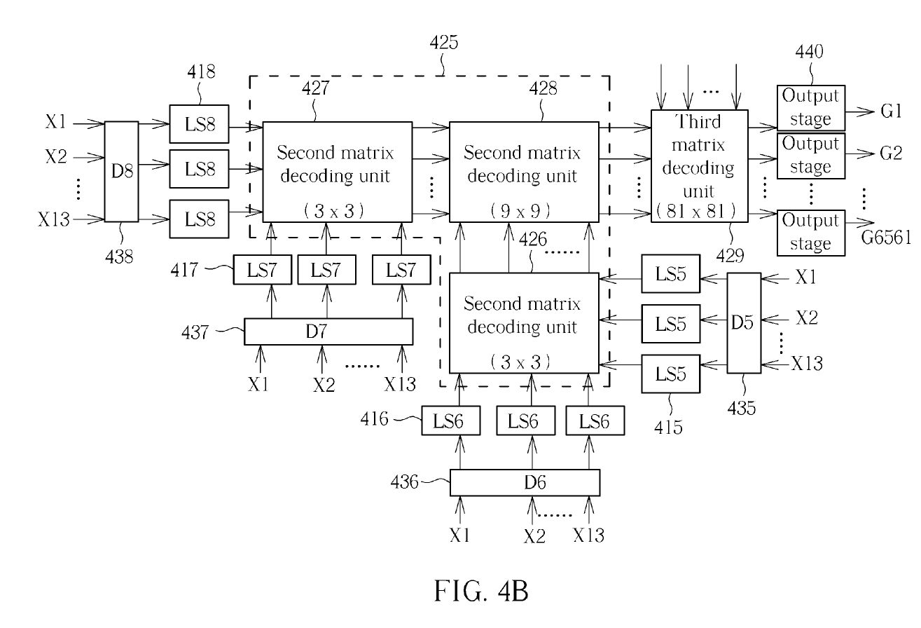

Please refer to FIG. 4A and FIG. 4B. FIG. 4A and FIG. 4B show a simplified block diagram of a gate driver 400 applied to a LCD panel in accordance with a second embodiment of the present invention. As shown in FIG. 4A and FIG. 4B, the driving circuit 400 comprises: three first level shifting units (LS1) 411, three second level shifting units (LS2) 412, three third level shifting units (LS3) 413, three fourth level shifting units (LS4) 414, three fifth level shifting units (LS5) 415, three sixth level shifting units (LS6) 416, three seventh level shifting units (LS7) 417, three eighth level shifting units (LS8) 418, a first decoding unit (D1) 431, a second decoding unit (D2) 432, a third decoding unit (D3) 433, a fourth decoding unit (D4) 434, a fifth decoding unit (D5) 435, a sixth decoding unit (D6) 436, a seventh decoding unit (D7) 437, a eighth decoding unit (D8) 438, a first matrix decoding module 420, a second matrix decoding module 425, a (81×81) third matrix decoding module 429, and 6561 output stages 440. The first matrix decoding module 420 comprises a (3×3) first matrix decoding unit 421, a (3×3) first matrix decoding unit 422, and a (9×9) first matrix decoding unit 423. The second matrix decoding module 425 comprises a (3×3) second matrix decoding unit 426, a (3×3) second matrix decoding unit 427, and a (9×9) second matrix decoding unit 428. The first matrix decoding unit 423 shown in FIG. 4A is coupled to the third matrix decoding module 429 shown in FIG. 4B. In addition, each of the 6561 output stages 440 is coupled to one of 6561 gate lines G1-G6561, respectively. In other words, the 6561 output stages 440 and the 6561 gate lines G1-G6561 are corresponding to each other one by one. In addition, please note that the above embodiment is only for an illustrative purpose and is not meant to be a limitation of the present invention. Similar with the gate driver 300 in the first embodiment of the present invention, the gate driver 400 of the present invention also can be designed in accordance with different required output signal amounts. The other practical embodiments are omitted herein for the sake of brevity.

Next, please note that since the second embodiment of the present invention is developed base on of the first embodiment of the present invention, and the internal circuit structure and the operation scheme of the gate driver 400 are the same as those of the gate driver 300, and the internal circuit structure and the operation scheme of the gate driver 400 are omitted herein for the sake of brevity. In addition, a person of average skill in the pertinent art should be able to easily understand that various modifications and alterations of the gate driver should fall into the disclosed scope of the present invention as long as the gate driver has a hierarchical matrix decoder made up by a plurality of matrix decoding units.

Briefly summarized, the driving circuit provided by the present invention can significantly decrease the amount of the required high voltage elements (i.e. the level shifting units) in comparison with the gate driver of the U.S. Publication No. 20070103346 in the prior art, and thus the present invention can reduce area of the driving circuit efficiently.

Those skilled in the art will readily observe that numerous modifications and alterations of the device and method may be made while retaining the teachings of the invention.

What is claimed is:

1. A driving circuit, comprising:
an amount Z of first level shifting units, for respectively receiving one of an amount Z of first low voltage digital input signals, and for generating an amount Z of first high voltage digital input signals in accordance with the amount Z of first low voltage digital input signals;
an amount B of second level shifting units, for respectively receiving one of an amount B of second low voltage digital input signals, and for generating an amount B of second high voltage digital input signals in accordance with the amount B of second low voltage digital input signals;
a first matrix decoding unit, coupled to the amount Z of first level shifting units and the amount B of second level shifting units, for receiving the amount Z of first high voltage digital input signals and the amount B of second high voltage digital input signals, and for generating an amount (Z×B) of first high voltage digital output signals in accordance with the amount Z of first high voltage digital input signals and the amount B of second high voltage digital input signals;
an amount C of third level shifting units, for respectively receiving one of an amount C of third low voltage digital input signals, and for generating an amount C of third high voltage digital input signals in accordance with the amount C of third low voltage digital input signals;
an amount D of fourth level shifting units, for respectively receiving one of an amount D of fourth low voltage digital input signals, and for generating an amount D of fourth high voltage digital input signals in accordance with the amount D of fourth low voltage digital input signals;
a second matrix decoding unit, coupled to the amount C of third level shifting units and the amount D of fourth level shifting units, for receiving the amount C of third high voltage digital input signals and the amount D of fourth high voltage digital input signals, and for generating an amount (C×D) of second high voltage digital output signals in accordance with the amount C of third high voltage digital input signals and the amount D of fourth high voltage digital input signals; and
a third matrix decoding unit, coupled to the first matrix decoding unit and the second matrix decoding unit, for receiving the amount (Z×B) of first high voltage digital output signals and the amount (C×D) of second high voltage digital output signals, and for generating an amount (Z×B)×(C×D) of third high voltage digital output signals in accordance with the amount (Z×B) of first high voltage digital output signals and the amount (C×D) of second high voltage digital output signals.

2. The driving circuit of claim 1, further comprising:
a first decoding unit, coupled to the amount Z of first level shifting units, for receiving a plurality of digital control signals, and for generating the amount Z of first low voltage digital input signals in accordance with at least a portion of the plurality of digital control signals;
a second decoding unit, coupled to the amount B of second level shifting units, for receiving the plurality of digital control signals, and for generating the amount B of second low voltage digital input signals in accordance with at least a portion of the plurality of digital control signals;
a third decoding unit, coupled to the amount C of third level shifting units, for receiving the plurality of digital control signals, and for generating the amount C of third low voltage digital input signals in accordance with at least a portion of the plurality of digital control signals; and
a fourth decoding unit, coupled to the amount D of fourth level shifting units, for receiving the plurality of digital control signals, and for generating the amount D of fourth low voltage digital input signals in accordance with at least a portion of the plurality of digital control signals.

3. The driving circuit of claim 1, further comprising:
an amount (Z×B)×(C×D) of output stages, coupled to the third matrix decoding unit, for receiving the amount (Z×B)×(C×D) of third high voltage digital output signals.

4. The driving circuit of claim 1, being a gate driver applied to a LCD panel.

5. A driving circuit, comprising:
an amount Z of first level shifting units, for respectively receiving one of an amount Z of first low voltage digital input signals, and for generating an amount Z of first high voltage digital input signals in accordance with the amount Z of first low voltage digital input signals;
an amount B of second level shifting units, for respectively receiving one of an amount B of second low voltage digital input signals, and for generating an amount B of second high voltage digital input signals in accordance with the amount B of second low voltage digital input signals;
a first matrix decoding unit, coupled to the amount Z of first level shifting units and the amount B of second level shifting units, for receiving the amount Z of first high voltage digital input signals and the amount B of second high voltage digital input signals, and for generating an amount (Z×B) of first high voltage digital output signals in accordance with the amount Z of first high voltage digital input signals and the amount B of second high voltage digital input signals;
a plurality groups of third level shifting units, each group of third level shifting units for respectively receiving one of a plurality of third low voltage digital input signals, and for generating a plurality of third high voltage digital input signals in accordance with the plurality of third low voltage digital input signals;
a matrix decoding module, for generating an amount (C×D) of second high voltage digital output signals, the matrix decoding module comprising a plurality of second matrix decoding units, each of the plurality of second matrix decoding units for generating a plurality of output signals in accordance with a plurality of first input signals and a plurality of second input signals, wherein an amount of the plurality of output signals is equal to a product of an amount of the plurality of first input signals and an amount of the plurality of second input signals, the plurality of first input signals are outputs of an adjacent second matrix decoding unit or outputs of one group of third level shifting units in the plurality groups of third level shifting units, and the plurality of second input signals are outputs of an adjacent second matrix decoding unit or outputs of one group of third level shifting units in the plurality groups of third level shifting units, and a product of amounts of each group of third level shifting units in the plurality groups of third level shifting units is equal to (C×D); and
a third matrix decoding unit, coupled to the first matrix decoding unit and the matrix decoding module, for receiving the amount (Z×B) of first high voltage digital output signals and the amount (C×D) of second high voltage digital output signals, and for generating an amount (Z×B)×(C×D) of third high voltage digital output signals in accordance with the amount (Z×B) of first high voltage digital output signals and the amount (C×D) of second high voltage digital output signals.

6. The driving circuit of claim 5, further comprising:
a first decoding unit, coupled to the amount Z of first level shifting units, for receiving a plurality of digital control signals, and for generating the amount Z of first low voltage digital input signals in accordance with at least a portion of the plurality of digital control signals;
a second decoding unit, coupled to the amount B of second level shifting units, for receiving the plurality of digital control signals, and for generating the amount B of second low voltage digital input signals in accordance with at least a portion of the plurality of digital control signals; and
a plurality of third decoding unit, respectively corresponding to the plurality groups of third level shifting units, each of the plurality of third decoding unit for receiving the plurality of digital control signals, and for generating the plurality of third low voltage digital input signals in accordance with at least a portion of the plurality of digital control signals to a corresponding group of third level shifting units.

7. The driving circuit of claim 5, further comprising:
an amount (Z×B)×(C×D) of output stages, coupled to the third matrix decoding unit, for receiving the amount (Z×B)×(C×D) of third high voltage digital output signals.

8. The driving circuit of claim 5, being a gate driver applied to a LCD panel.

9. A driving circuit, comprising:
a plurality groups of first level shifting units, each group of first level shifting units for respectively receiving one of a plurality of first low voltage digital input signals, and for generating a plurality of first high voltage digital input signals in accordance with the plurality of first low voltage digital input signals;
a first matrix decoding module, for generating an amount (Z×B) of first high voltage digital output signals, the matrix decoding module comprising a plurality of first matrix decoding units, each of the plurality of first matrix decoding units for generating a plurality of first output signals in accordance with a plurality of first input signals and a plurality of second input signals, wherein an amount of the plurality of first output signals is equal to a product of an amount of the plurality of first input signals and an amount of the plurality of second input signals, the plurality of first input signals are outputs of an adjacent first matrix decoding unit or outputs of one group of first level shifting units in the plurality groups of first level shifting units, and the plurality of second input signals are outputs of an adjacent first matrix decoding unit or outputs of one group of first level shifting units in the plurality groups of first level shifting units, and a product of amounts of each group of first level shifting units in the plurality groups of first level shifting units is equal to (Z×B);
a plurality groups of second level shifting units, each group of second level shifting units for respectively receiving one of a plurality of second low voltage digital input signals, and for generating a plurality of second high voltage digital input signals in accordance with the plurality of second low voltage digital input signals;
a second matrix decoding module, for generating an amount (C×D) of second high voltage digital output signals, the second matrix decoding module comprising a plurality of second matrix decoding units, each of the plurality of second matrix decoding units for generating a plurality of second output signals in accordance with a plurality of first input signals and a plurality of second input signals, wherein an amount of the plurality of second output signals is equal to a product of an amount of the plurality of first input signals and an amount of the plurality of second input signals, the plurality of first input signals are outputs of an adjacent second matrix decoding unit or outputs of one group of second level shifting units in the plurality groups of second level shifting units, and the plurality of second input signals are outputs of an adjacent second matrix decoding unit or outputs of one group of second level shifting units in the plurality groups of second level shifting units, and a product of amounts of each group of second level shifting units in the plurality groups of second level shifting units is equal to (C×D); and
a third matrix decoding unit, coupled to the first matrix decoding module and the second matrix decoding module, for receiving the amount (Z×B) of first high voltage digital output signals and the amount (C×D) of second high voltage digital output signals, and for generating an amount (Z×B)×(C×D) of third high voltage digital output signals in accordance with the amount (Z×B) of first high voltage digital output signals and the amount (C×D) of second high voltage digital output signals.

10. The driving circuit of claim 9, further comprising:
a plurality of first decoding unit, respectively corresponding to the plurality groups of first level shifting units, each of the plurality of first decoding unit for receiving the plurality of digital control signals, and for generating the plurality of first low voltage digital input signals in accordance with at least a portion of the plurality of digital control signals to a corresponding group of first level shifting units; and
a plurality of second decoding unit, respectively corresponding to the plurality groups of second level shifting units, each of the plurality of second decoding unit for receiving the plurality of digital control signals, and for generating the plurality of second low voltage digital input signals in accordance with at least a portion of the plurality of digital control signals to a corresponding group of second level shifting units.

11. The driving circuit of claim 9, further comprising:
an amount (Z×B)×(C×D) of output stages, coupled to the third matrix decoding unit, for receiving the amount (Z×B)×(C×D) of third high voltage digital output signals.

12. The driving circuit of claim 9, being a gate driver applied to a LCD panel.
